(19) United States
(12) Patent Application Publication
(10) Pub. No.: US 2013/0101837 A1
(43) Pub. Date: Apr. 25, 2013

(54) RADIATION CURABLE COATINGS FOR CONCRETE FLOORS

(71) Applicants: Huimin Cao, Addison, IL (US); Wenguang Li, St. Charles, IL (US); Tai Yeon Lee, Crystal Lake, IL (US)

(72) Inventors: Huimin Cao, Addison, IL (US); Wenguang Li, St. Charles, IL (US); Tai Yeon Lee, Crystal Lake, IL (US)

(73) Assignee: DSM IP ASSETS B.V., Heerlen (NL)

(21) Appl. No.: 13/807,899

(22) PCT Filed: Jun. 30, 2011
(86) PCT No.: PCT/US2011/042489

§ 371 Date: Dec. 31, 2012

Related U.S. Application Data
(60) Provisional application No. 61/363,118, filed on Jul. 9, 2010.

(30) Foreign Application Priority Data
Jul. 19, 2010 (EP) 10169997.3

(51) Int. Cl. B05D 3/06; C09D 133/14

(52) U.S. Cl. CPC B05D 3/067; C09D 133/14
USPC 428/339; 522/121; 522/42; 427/510

(57) ABSTRACT

Radiation-curable coating compositions for a surface such as a concrete floor, which include at least one multi-functional monomer or oligomer, a polymer, at least one photoinitiator, and one or more tertiary amine compounds containing zero or one crosslinkable double bonds are described and claimed. These coating compositions allow for application of at least about 0.15 mm (6 mil) thickness of the coating composition over an area larger than a UV radiation source, without the formation of wrinkles or buckles following each pass of the UV radiation source in the areas where light leakage from a side light shielding of the UV radiation source results in a very weak radiation intensity. These coating compositions are optionally clear, in addition, a method for coating a surface with a radiation-curable coating composition that results in a smooth cured surface with no wrinkles or buckles formed following each pass of the UV radiation source, and a surface coated with the radiation curable coating compositions of the instant claimed invention are described and claimed.

### FIELD OF THE INVENTION

The invention relates to the field of radiation-curable coatings. More particularly, this invention is related to the field of radiation-curable floor coatings, for instance concrete floor coatings.

### BACKGROUND OF THE INVENTION

Radiation-curable coatings have been applied to surfaces in various industries for decades. Radiation-curable coatings have also been employed, for example, on surfaces such as concrete floors, vinyl, wood, and the like. As the name implies, radiation-curable coatings are cured by exposure to radiation, such as from UV light, visible light, and electron beams.

A subset of radiation-curable coatings is UV-curable coatings. UV-curable coatings are cured by exposure to at least UV radiation; for instance the UV portion of the electromagnetic spectrum, which includes radiation wavelengths of about 100-400 nanometers (nm). Higher wavelengths of radiation may also be included in addition to the UV radiation.

UV-curable coatings comprise components referred to as “photoinitiators” that absorb UV radiation and are thus raised to an excited state. The photoinitiators then either photolyze or degrade into cations or free radicals, which are extremely reactive species. The cations or free radicals react with the oligomers and/or monomers also present in the UV-curable coatings and polymerize to form cured coatings almost instantaneously, such as within seconds.

One benefit of using UV-curable coatings on floor surfaces is the quick speed at which the coatings are cured. Such rapid curing allows for return to normal use of the floor without lengthy delays as required by alternate coatings, such as coatings containing solvents that must evaporate, or coatings that substantially completely cure over a time span of hours to days. Another benefit provided by many UV-curable coatings is their strong mechanical and chemical resistance. For example, certain UV-curable coatings applied to floor surfaces can withstand the weight and friction of a forklift driving on the cured, coated surface within minutes after the UV curing. A further benefit of certain UV-curable coatings is that they comprise 100% solids, and thus do not include volatile organic components in the coating formulations, which allows personnel to work in the area without having significant respiratory health concerns from inhalation of volatile organic components. An additional benefit of UV-curable coatings is that the fact that the polymerization reaction is initiated using UV radiation means that the coating formulation does not have a “pot life”, which refers to the need to use the coating within a certain period of time before it polymerizes in its own container, due to having been mixed with a reactive component. Being a one-component formulation helps eliminate waste from individual projects, as unused coating may be stored for future use.

UV curable concrete coatings are further discussed in the article, “UV Curable Concrete Coatings” by Jo Ann Arceneaux, published in the January/February/March 2009 RADTECH Report; in the article, “Field-Applied, UV-Curable Coatings for Concrete Flooring”, by Peter T. Weissman, published in the January/February/March 2009 RADTECH Report; and in the presentation, “Field Applied UV Coatings for Concrete”, by Peter T. Weissman, presented at the UV/EB East October 2009.

U.S. Patent Publication No. 2002/0164434 discloses a radiation curable floor coating that includes an indicator for determining when curable coatings have cross-linked or cured thereby permitting the applier to know what part of the floor may be used without affecting the surface and what part is still in the curing process. The publication discloses incorporation of a dye or pigment into the liquid materials which dye or pigment is visible to the naked eye when the coating is in the liquid state and significantly less visible after the coating has cured.

A drawback to UV-curable coatings for large surfaces relates to the use of UV radiation sources that are smaller in at least one direction, such as width, than the surface to be cured. For example, typical UV curing instruments are portable machines having a cure width of between about 0.66 meters (26 inches) and about 0.86 meters (34 inches). To cure a large floor surface, then, the machine must be passed over the floor, curing an area of just 0.66-0.86 meters (26-34 inches) wide at a time across the length of the floor, followed by passing over and curing another area, the width of the machine, directly adjacent to the prior area. The one or more lamps, bulbs, and/or light emitting diodes (LEDs) fixed to the UV curing instrument direct emitted UV radiation at the floor surface to cure the coating, such as at a power of between about 4000-20000 watts per meter (100-500 watts per inch). Despite advances to the design of such portable UV radiation sources, there still exists a stray light zone at the edges of the cure unit where low intensity light leakage from the side light shielding of the machine is sufficient to initiate polymerization of coatings at a certain thickness near the surface and partially cure it to a skin layer, but insufficient to drive the polymerization of coatings to the entire thickness and therefore leaving a liquid layer at the bottom of the coating.

Such light leakage adjacent the side edges of the light shield of the UV radiation source typically results in the formation of a wrinkle in the partially cured coating skin layer within seconds of passing the UV curing instrument over the coating. The wrinkle is also referred to as a “buckle”, which exhibits a nonplanar wave pattern that is formed by buckling of the otherwise planar cured portion of the coating located on the top surface of the coating, whereas uncured wet coating remains between the cured portion and the substrate on which the coating was applied. The wrinkle or buckle remains visible at the cured surface, even upon complete curing of the entire thickness by the next curing pass. Each pass down the length of a floor may then be observed as a visible line located at or near the edge of the cured area, which is imparted by the wrinkle or buckle. The area located at or near the edge of the cured area from each curing pass may also be referred to as shoulder area.

A radiation gradient present at the front of a UV radiation source is rarely problematic, because as the UV radiation source proceeds forward, emitted full intensity radiation will quickly drive the polymerization reaction to completion. Similarly, a radiation gradient present at the back of a UV radiation source is not an issue as the coating at which such weak intensity light is directed has already been fully cured.

Typically, wrinkles are not an issue for clear coatings applied at a thickness of less than about 0.15 mm (6 mils), as even stray light can usually cure through the most thickness of coating to certain cure degree, whereas many UV-curable coatings applied at a thickness of about 0.15 mm (6 mils) or more are subject to wrinkling.

The formation of wrinkles has historically been a problem for UV coatings in field applied floor applications, in which the surface to be cured is larger than the UV radiation source, and no effective solution to the wrinkle formation problem has been reported. Indeed, the issue of wrinkle formation is reported in Weissman's UV/EB East 2009 presentation, which discloses on page 15 that wrinkling is “[c]aused by differential cure top to bottom within the film and laterally outside the primary exposure line of sight.” This presentation further states on page 16 that wrinkling is “[p]articularly problematic in colors, matte and high build (>8 mils) coatings.”

Typically, the current approach to minimize the appearance of the wrinkles in the final finish is by reducing the magnitude of the wrinkle of a clear primer or color coat and then to use a thin topcoat to attempt to cover up any visible wrinkles.

It would be advantageous to provide a UV-curable coating formulation that would allow for the application of the coating over an area larger than a UV radiation source, without the formation of wrinkles along or near the edge of each pass of the UV radiation source, in the shoulder areas where weak intensity light from a side edge of the UV radiation source is capable of partially curing only a portion of the coating thickness near the surface. In addition, it would be advantageous to provide a method for coating a surface, for example a concrete floor, with a UV-curable coating that provides a cured surface free of wrinkles formed by partial UV curing from stray light from the UV radiation source.

### SUMMARY OF THE INVENTION

The invention may be embodied in various exemplary and nonlimiting forms. In particular, this Summary is intended merely to illuminate various embodiments of the invention and does not pose a limitation on the scope of the invention.

In a first embodiment, a radiation-curable coating composition for a floor is provided. The coating composition comprises at least one multifunctional monomer or oligomer, at least one photoinitiator, at least one polymer, and one or more tertiary amine compounds comprising zero or one acrylate crosslinkable double bonds.

In another embodiment, a method for coating a concrete floor is provided. The method comprises applying a coating composition in a predetermined area over a surface of a concrete floor. The coating composition comprises at least one multifunctional monomer or oligomer, at least one photoinitiator, at least one polymer, and one or more tertiary amine compounds comprising zero or one crosslinkable double bonds. Suitable tertiary amine compounds also include the salts of such compounds.

The coating composition comprises a thickness of at least about 0.15 mm on the surface. The method further comprises passing a UV radiation source over a first portion of the predetermined area of the surface to cure the coating composition, wherein a shoulder area of the predetermined area that includes partially cured coating, that is directly adjacent the first portion and that has not had the UV radiation source pass directly over it, has no wrinkles two minutes following the completion of the passing of the UV radiation source over the first portion.

In another embodiment, a coated concrete floor is provided. The coated concrete floor comprises a concrete floor comprising a surface and a radiation-curable coating composition applied directly to the surface, the coating composition comprising at least one multifunctional monomer or oligomer, at least one photoinitiator, at least one polymer, and one or more tertiary amine compounds. The coating composition has a thickness of at least 0.15 mm.

In another embodiment, a coated concrete floor is provided that is coated by the method comprising applying a radiation-curable coating composition in a predetermined area over a surface of a concrete floor, the coating composition comprising at least one multifunctional monomer or oligomer, at least one photoinitiator, at least one polymer, and one or more tertiary amine compounds comprising zero or one crosslinkable double bonds, wherein the cured coating composition comprises a thickness of at least about 0.15 mm; and passing a UV radiation source over a first portion of the predetermined area of the surface to cure the coating composition, wherein a shoulder area of the predetermined area that includes partially cured coating, that is directly adjacent the first portion and that has not had the UV radiation source pass directly over it, has no wrinkles two minutes following the completion of the passing of the UV radiation source over the first portion.

Other features and advantages of the invention will become apparent to those skilled in the art upon review of the following detailed description, claims and drawings.

### BRIEF DESCRIPTION OF THE FIGURES

FIG. 1 is a photograph of a prior art color coating that has been cured on one side with UV radiation, illustrating the formation of a wrinkle adjacent to the completely cured area.

FIG. 2 is subdivided into two figures.

FIG. 2a is a photograph of a prior art color coating that has been cured using two passes of a UV radiation source, with a delay of about five seconds between the two passes.

FIG. 2b is a photograph of a prior art color coating that has been cured using two passes of a UV radiation source, with a delay of about thirty seconds between the two passes.

FIG. 3 is subdivided into two figures.

FIG. 3a is a photograph of a prior art color coating applied at a thickness of 4 mils.

FIG. 3b is a photograph of a prior art color coating applied at a thickness of 6 mils.

FIG. 4 is a photograph of a cross section of the wrinkle area of the color coating of FIG. 3h, under microscope of 20× magnification.

FIG. 4-2 is a photograph of a prior art clear coating according to Table 10 below that was applied at a thickness of 0.25 mm (10 mil) that has been cured using two passes of a UV radiation source, with a delay of about one minute between the two passes.

FIG. 4-3 is a photograph of a cross section of the wrinkle area of the coating of FIG. 4-2 under a microscope of 10× magnification.

FIG. 5 is a photograph of a cross section of an inventive coating applied at a thickness of 6 mils, according to an embodiment, under microscope of 20× magnification.

FIG. 6 is a perspective view of a commercially available UV floor curing machine.

FIG. 7 is a graph of peak measured irradiance versus distance from the edge of the light shield of a UV floor curing machine.

FIG. 8 is a partial drawing of a bulb and a shield of a UV radiation source.

FIG. 9a is partial diagram of a large surface coated with a radiation-curable coating, over which one pass of a UV radiation source has been made.

FIG. 9b is a partial diagram of the surface of 9a, over which a second pass of a UV radiation source has been made.

FIG. 10 is a perspective cross-section view of a prior art clear primer and a prior art clear topcoat.

FIG. 11 is a perspective cross-section view of an inventive clear primer coating and an inventive clear topcoat coating.

FIG. 12 is a perspective cross-section view of a rough concrete surface coated with a thick clear coating, according to an embodiment of the invention.

FIG. 13 is a photograph of a coated floor according to an embodiment of the invention.

FIG. 14 is a photograph of the wrinkle area of a prior art clear coating applied to a concrete surface at a thickness of 0.25 mm (10 mils) that has been cured using two passes of a UV radiation source.

FIG. 15 is a photograph of an inventive clear coating applied to a concrete surface at a thickness of 0.25 mm (10 mils) that has been cured using two passes of a UV radiation source.

### DETAILED DESCRIPTION OF THE INVENTION

### Definitions

The term “wrinkles” is defined to mean a visible wave pattern where the thickness at the valleys of the wave is thinner than the thickness at the flat film area and the thickness at the peaks of the wave is thicker than the thickness at the flat film area. The difference between the thickness at the peak areas and the thickness at the valley areas are at least about 10 μm. The terms “wrinkling”, “buckling” and “zippering” are synonymous and used interchangeably herein, as are the terms “wrinkle”, “buckle” and “zipper”.

The term “flat film area” is defined to mean an area of cured film where the surface of the film is planar.

The term “planar” is defined to mean a surface that generally extends in only one plane and does not include out-of-plane wavelike deformation patterns. A coating that does not comprise wrinkles or buckles is planar, whereas a coating that does comprise wrinkles or buckles is nonplanar.

The term “shoulder area” is defined as comprising a first longitudinal edge located immediately adjacent the area of coating directly over which a UV radiation source has been passed. The shoulder area comprises partially cured coating, which has been subjected to weak intensity UV radiation leaked from the side edge of the UV radiation source. The shoulder area is further defined as comprising a second longitudinal edge located at the boundary of the partially cured coating and the coating that remains uncured.

It is possible that the shoulder area can have coating cured to the bottom, but the coating is only partially cured. The term “partially cured” means that the double bond conversion is low. Therefore, in the shoulder area, it is expected that the coating is partially cured to the bottom, but this partial cure is not to the degree of full cure as in the bulk area. Similarly, the term “partial cure degree” refers to a radiation curable coating that has undergone polymerization; however the double-bond conversion of the polymerization is not complete.

As used herein, the term “about” means±10% of the stated value.

### DESCRIPTION

Aspects of the invention are directed to UV-curable coatings for surfaces, such as concrete floors, methods for coating UV-curable coatings onto a surface, and surfaces coated with cured UV-curable coatings.

As noted above, it would be advantageous to provide a UV-curable coating formulation that is capable of allowing the application of the coating at a thickness of at least about 0.15 mm (6 mils) over an area larger than a UV radiation source, without the formation of wrinkles in the shoulder area along or near the edge of each pass of the UV radiation source in the areas where weak intensity light from a side edge of the UV radiation source is capable of partially curing only a portion of the coating thickness near the surface. A shoulder area, as noted above, is the area of coating defined as comprising a first longitudinal edge located immediately adjacent the area of coating directly over which a UV radiation source has been passed. The shoulder area comprises partially cured coating, which has been subjected to weak intensity UV radiation leaked from the side edge of the UV radiation source. The shoulder area is further defined as comprising a second longitudinal edge located at the boundary of the partially cured coating and the coating that remains uncured. The width of any shoulder area would depend on various characteristics of the specific coating and UV radiation source, such as coating thickness, coating composition, and UV radiation intensity.

In some aspects of the instant claimed invention the shoulder area has a width of from about 0.1 cm to about 10 cm. In some aspects the shoulder area has a width of at least about 0.5 cm. In some aspects the shoulder area has a width of from about 0.2 to about 5.0 cm. In an aspect of the invention the shoulder area has a width of approximately about 2.0 cm to about 3.0 cm. In aspects the width of the shoulder area will be controlled in part by the type of UV radiation source used and the method of such use.

In addition, it would be advantageous to provide a method for coating a surface, for example a concrete floor, with a UV-curable coating that provides a cured surface free of wrinkles formed by partial UV curing from stray light from the UV radiation source.

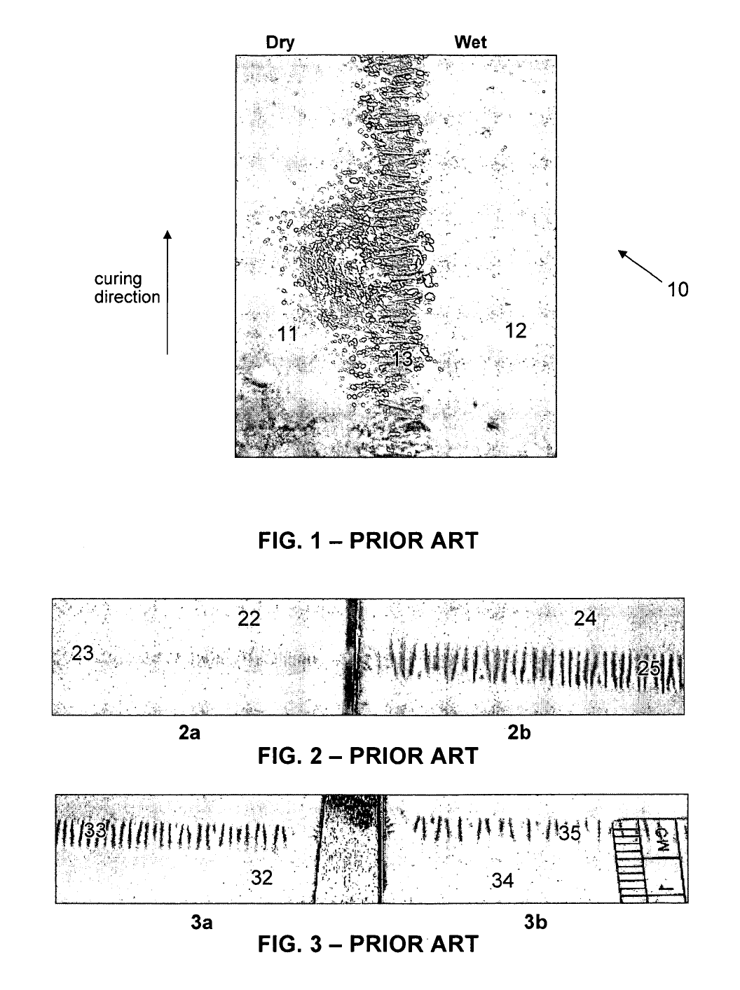

Referring to the drawings, wherein like numbers refer to like elements, FIG. 1 shows a photograph of a 0.13 mm (5 mil) thick gray pigmented prior art coating composition applied to a concrete floor, which illustrates the formation of a wrinkle when only a portion of the coated area 10 is cured. A UV radiation source was passed over a portion of the wet coated area 10 to form a section 11 comprising dry, cured coating, a section 12 comprising wet, uncured coating, and a section 13 comprising partially cured, wrinkled coating. The photograph was taken about one minute following passing of the radiation source over the left portion 11 of the coating.

In addition to the term “wrinkling”, the phenomenon of curing of a coating composition at the surface while uncured coating remains underneath has also been referred to as “buckling” or “zippering”, due to the appearance of the partially cured area. The terms “wrinkling”, “buckling” and “zippering” are synonymous and used interchangeably herein, as are the terms “wrinkle”, “buckle” and “zipper”. In general, a wrinkled section 13 comprises a visible pattern of folded, partially cured coating surface segments that are disposed approximately perpendicular to the length of the wrinkled section 13, as shown in FIG. 1. Typically, the individually visible wrinkles have a fairly well defined wave pattern with certain wavelength, rather than randomly located wrinkles.

A coating that does not comprise wrinkles or buckles is planar, whereas a coating that does comprise wrinkles or buckles is nonplanar. The magnitude, or height, of each wrinkle or buckle typically increases over time until the partially cured coating composition is subjected to the next pass of UV radiation of sufficient intensity to drive the polymerization reaction to completion, at which time the height of the wrinkles or buckles becomes fixed. Referring to FIG. 2, photos are provided of cured prior art gray pigmented coatings. FIG. 2a shows the prior art composition that has been applied to a concrete floor at a thickness of 0.10 mm (4 mils). A UV radiation source was passed over a portion of the wet coated area to form a section comprising dry, cured coating, a section comprising wet, uncured coating, and a section comprising partially cured, wrinkled coating. Next, the UV radiation source was passed over the remaining uncured section of the coating just about five seconds following passing of the UV radiation source over the first portion of the coating composition. A visible wrinkle 23 formed in the coating 22 after a time lapse of only about five seconds between the two passes of the UV radiation source.

In contrast, FIG. 2b shows the prior art composition that has been applied to a concrete floor at a thickness of 0.10 mm (4 mils). The only difference in the cured coating 24 of FIG. 2b and the cured coating 22 of FIG. 2a is that the second pass of the UV radiation source took place about thirty seconds after the first pass of the UV radiation source. The visible wrinkle 25 that formed in the coating 24 after about thirty seconds of delay between the first and second passes of the UV radiation source is significantly larger than the visible wrinkle 23 that formed in the coating 22 after about five seconds of delay between the first and second passes of the UV radiation source. For example, the magnitude and length of each buckle or wrinkle demonstrate a substantial increase between a delay of about five seconds and a delay of about thirty seconds between the first and second passes of the UV radiation source.

Moreover, the magnitude of each wrinkle or buckle is typically proportional to the thickness of the applied coating. For instance, FIG. 3 shows photos of cured prior art gray pigmented coatings having different thicknesses. FIG. 3a shows the prior art composition that has been applied to a concrete floor at a thickness of 0.10 mm (4 mils). A UV radiation source was passed over a portion of the wet coated area to form a section comprising dry, cured coating, a section comprising wet, uncured coating, and a section comprising partially cured, wrinkled coating that was adjacent the section of dry, cured coating. Next, the UV radiation source was passed over the remaining uncured section and the partially cured section of the coating about thirty seconds following passing of the UV radiation source over the first portion of the coating composition. A visible wrinkle 33 formed in the coating 32 after a time lapse of about thirty seconds between the two passes of the UV radiation source.

In contrast, FIG. 3b shows the prior art composition that has been applied to a concrete floor at a thickness of 0.15 mm (6 mils). The only difference in the cured coating 34 of FIG. 3b and the cured coating 32 of FIG. 3a is that the coating composition of FIG. 3b was applied at a thickness of 0.05 mm (2 mils) greater than the thickness of the coating composition of FIG. 3a. The applied coating of FIG. 3b was cured by the same method as the applied coating of FIG. 3b, having a time lapse of about thirty seconds between the two passes of the UV radiation source. The visible wrinkle 35 that formed in the coating 34, which had been applied at a thickness of 0.15 mm (6 mils), is significantly larger than the visible wrinkle 33 that formed in the coating 32, which had been applied at a thickness of 0.10 mm (4 mils). For example, the magnitude and length of each buckle or wrinkle demonstrate a substantial increase between coatings applied at a thickness of 0.15 mm (6 mils) as compared to 0.10 mm (4 mils). Consequently, both the time lapse between UV curing passes and the coating thickness are proportional to the size of the wrinkle or buckle formed in the coating.

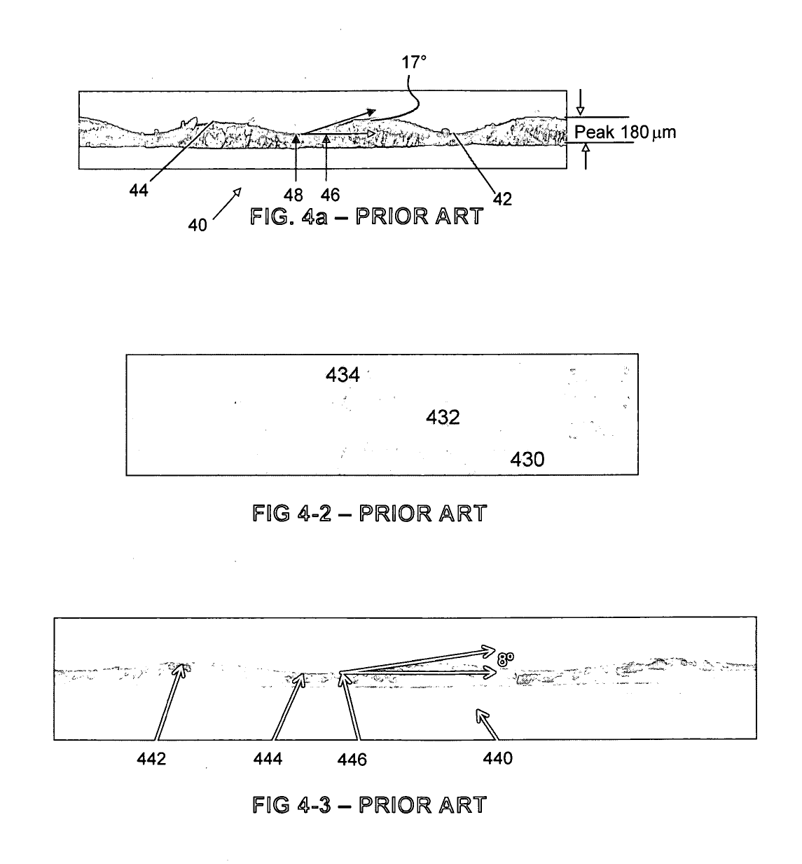

FIG. 4 provides an image of a cross section of the cured color coating 34 at the shoulder area of FIG. 3b, under a microscope of 20× magnification. The microscope image of the cured coating cross section 40 illustrates the wave shape of the wrinkles. The thickness of the cured coating 34 in a planar, nonbuckled, region of the coating was measured to be about 130 μm (about 5.12 mils) (0.13 mm) thick. The thickness of the valleys 42 of the cross section 40 ranged from about 60 μm (about 2.36 mils) (0.06 mm) to about 100 μm (about 3.94 mils) (0.10 mm) thick. In contrast, the thickness of the peaks 44 of the cross section 40 was about 180 μm (about 7.09 mils) (0.18 mm) thick. The angle 46 of a wrinkle in FIG. 4 is 17 degrees from planar. The angle is measured along the increase in the wrinkle thickness beginning at the valley 48.

FIG. 4-2 shows a photo of a prior art coating according to Table 10 below that was applied by 0.25 mm (10 mil) thickness draw down bar. A radiation source was passed over a section 430 to cure this section and was not passed over a shoulder area 432. One minute later the radiation source was passed over the shoulder area 432 and a section 434 of the coating. The resulting coating displays wrinkles in the shoulder area 432. The wrinkle area has a width of approximately 0.5 cm.

FIG. 4-3 provides an image of a cross section of the cured wrinkle area 432 at the shoulder area of FIG. 4-2, under a microscope of 10x magnification. The microscope image of the cured wrinkle area cross section 440 illustrates the wave pattern of the wrinkles and illustrates peaks 442 and valleys 444. The coating thickness in the flat film, planar area 430 of FIG. 4-2 was 190 μm. The thickness of the coating at the peak 442 was 240 μm, which is thicker than the flat film area thickness; the thickness of the coating at the valley 444 was 130 μm, which is thinner than the flat film area thickness. The angle 446 of a wrinkle in FIG. 4-3 is 8 degrees from planar. The angle is measured along the increase in the wrinkle thickness beginning at the valley 444.

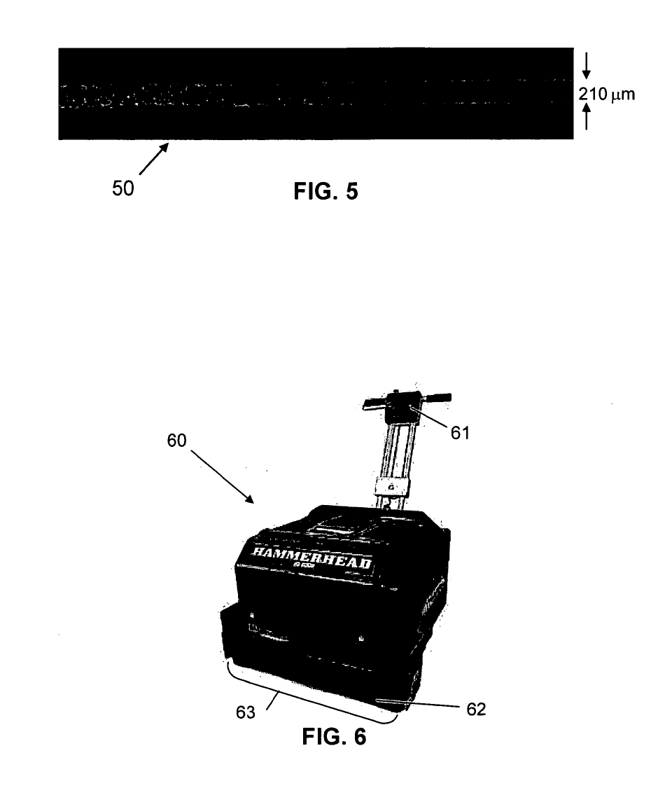

In contrast to FIGS. 4, 4-2 and 4-3, FIG. 5 provides an image of a cross section of an inventive cured coating at the shoulder area, under a microscope of 20× magnification. The microscope image of the cured coating cross section 50 illustrates that the unlike the peaks and valleys formed in buckled prior art coatings, an even thickness of about 210 μm was achieved throughout the coating composition. The coating was applied by 0.25 mm (10 mils) thickness draw down bar and cured with more than one pass of a UV radiation source, with a time lapse of about one minute between passes. The resulting coating was planar and wrinkle-free.

Referring to FIG. 6, one exemplary commercially available radiation source machine 60 is shown. The machine 60 is a Hammerhead UV Floor Curing Equipment model 26-8000A (HID Ultraviolet, Sparta, N.J.). In operation, a UV radiation source 60 directs radiation onto a coated surface to be cured, the radiation provided from mercury vapor lamps and/or bulbs affixed to a lower section 62 of the UV radiation source machine 60. As shown in the figure, the Hammerhead instrument 60 comprises a handle 61 and is thus a machine configured to be walked behind by an operator. The Hammerhead machine 60 shown in FIG. 2 comprises a cure path 63 of 0.66 m (26 inches); consequently, a plurality of passes will be necessary to completely cure the entire coated area for most floor surface applications. The speed at which a UV radiation source instrument may be passed over a surface is restricted by the amount of light required to drive the polymerization reaction to completion. Accordingly, the speed will depend on the characteristics of specific coating formulations. UV radiation source instrument speeds typically range between about 4.57 m (15 feet) per minute and about 15.24 m (50 feet) per minute, such as between about 6.10 m (20 feet) per minute and 12.20 m (40 feet) per minute, for instance about 7.62 m (25 feet) per minute. Radiation sources according to embodiments of the invention emit radiation, for example and without limitation, in the range of about 100 nm to about 700 nm or about 100 nm to about 500 nm.

An alternate radiation source is a machine comprising light emitting diodes (LEDs). LED radiation sources are disclosed in PCT Patent Application, PCT/US2010/60647, “D1446 BT LED Curing of Radiation Curable Floor Coatings” which claims priority to U.S. Provisional Patent Application No. 61/287,600 filed on Dec. 17, 2009. PCT Patent Application, PCT/US2010/60647 and U.S. Provisional Patent Application No. 61/287,600 are incorporated herein by reference in their entirety.

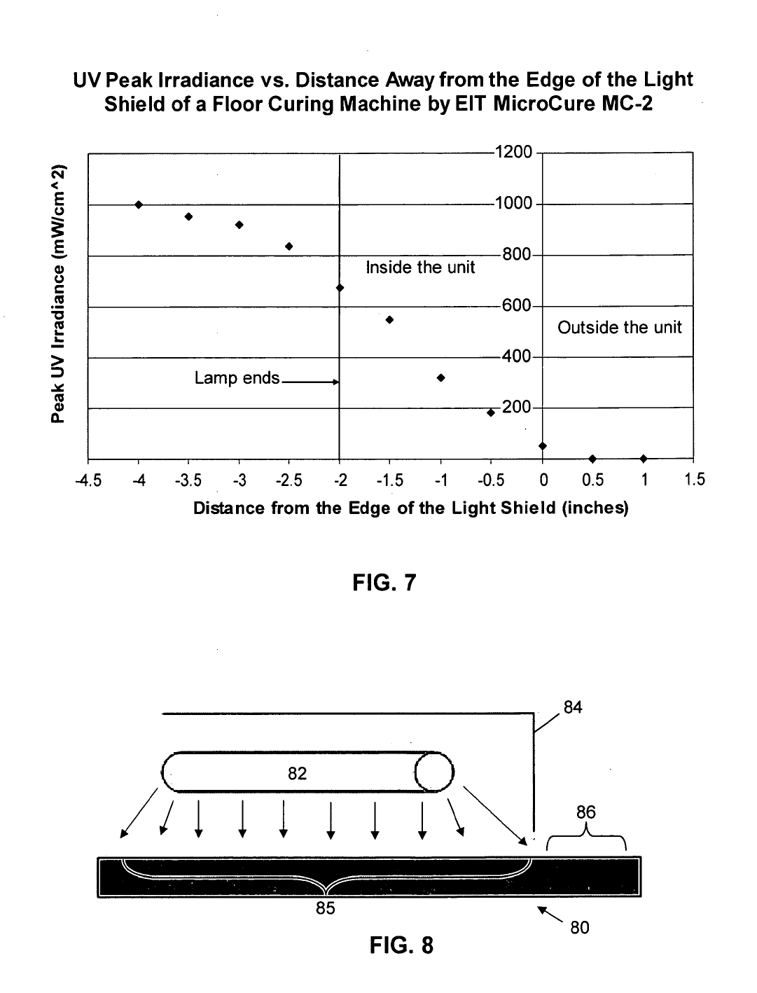

Radiation intensity can be measured at various locations with respect to a selected radiation source. For example, referring to FIG. 7, a graph is provided showing the UV-A (320-390 nm) peak irradiance for a mercury vapor bulb radiation source, as a function of the distance from the edge of the light shield. The irradiance was measured using a MicroCure MC-2 chip (EIT, Inc, Sterling, Va.). Each measurement was taken where the chip was placed on the floor, first directly in the path of the radiation emitted from the bulb. Next, the chip was placed half of an inch closer to one longitudinal side end of the bulb and the irradiance measured. For each subsequent measurement, the chip was placed an additional half of an inch closer to and then beyond the longitudinal side end of the bulb, past the light shield of the machine, and outside of the unit.

FIG. 7 illustrates the decrease in peak UV-A irradiance with respect to distance from the edge of the light shield. A typical UV-A radiation high intensity provided by such a bulb from the longitudinal center of the bulb is about 1700 mW/cm2. Between the end of the bulb and the edge of the light shield, the peak irradiance dropped from 673 mW/cm² to 53 mW/cm². Interestingly, even an irradiance as low as just 53 mW/cm² can be sufficient to cure the entire thickness of clear radiation-curable coatings having a thickness of about 0.15 mm (6 mils) to a partial cure degree.

It was only at half an inch or more outside of the equipment shield, where the irradiance was below the minimum detectable level of about 5-10 mW/cm², that partial curing only the skin layer from the stray light occurred. As one of skill in the art will appreciate, the distance longitudinally from the end of a radiation source at which the radiation is sufficiently weak to result in only partial curing the skin layer will depend on characteristics of the particular radiation source, such as the bulb, lamp or LED intensity, equipment shield configuration and location, distance of the radiation source from the coated surface, etc.

FIG. 8 provides a basic representation of the configuration of a UV radiation source lamp 82 and light shield 84 with respect to each other and a coated surface 80 to be cured. The arrows provide a depiction of the direction of the radiation provided by the lamp 82 as it is moved over the coated surface 80 during a curing pass. The main body area 85 of the coated surface 80, which is located directly below the lamp 82, receives direct high intensity light radiation, whereas the shoulder areas of the coated surface 80, which are off to the sides of the lamp 82, receive indirect light radiation. As indicated by the measurements shown in FIG. 7, a shoulder area 86, which is located on the coated surface 80 beyond the light shield 84, receives weak intensity radiation that leaks underneath and past the light shield 84. Typically, within this shoulder area 86 is where a buckle or wrinkle forms upon being subjected only to enough radiation to partially cure the skin layer of the coating.

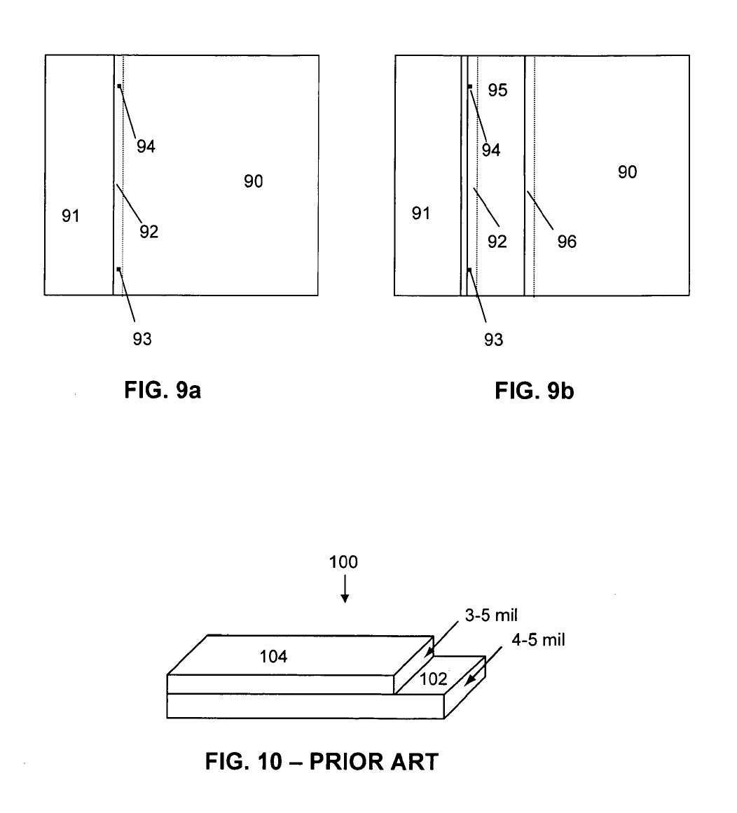

In use, a UV radiation source employed to cure a large surface coated with a radiation-curable composition will usually be passed over the surface as depicted in the representations shown in FIGS. 9a and 9b. Referring to FIG. 9a, a rectangular surface 90 is shown having a radiation-curable coating applied to the surface 90. The selected UV radiation source (not shown) is passed over the coated surface 90 starting at the lower left corner of the area shown in FIG. 9a and moving towards the upper left corner to cure the coated main body area 91 in the first pass. The weak intensity radiation that is provided adjacent to the high intensity radiation partially cures the skin layer of the coated shoulder area 92 despite the UV radiation source not passing over the shoulder area 92. The UV radiation source is passed over the coated surface at a suitable predetermined speed, such as between about 1.52 m (5 feet) and about 18.29 m (60 feet) per minute. Consequently, if more than one pass of a UV radiation source must be made over the coated area 90 in order to cure the entire width of the area, there will be a time lapse between the start of the first pass and the start of the second pass.

For instance, if the coated area 90 has a width of 3.05 m (10 feet) and a length of 3.05 m (10 feet), and a UV radiation source has a cure width of 0.86 m (34 inches) and a cure speed of about 105 m (10 feet) per minute, a first spot 93 located at approximately 0.89 m (35 inches) width and 0.15 m (6 inches) length (within the shoulder area 92) on the coated area 90 will become partially cured by the weak intensity stray radiation from the UV radiation source about 3 seconds into the first pass of the UV radiation source over the coated area 90. A second spot 94 located at approximately 0.89 m (35 inches) width and 2.90 m (9 feet 6 inches) length on the coated area 90 (also within the shoulder area 92) will become partially cured by weak intensity stray radiation from the UV radiation source at a time of about 57 seconds. Referring now to FIG. 9b, if the UV radiation source is then turned immediately around and passed over the second main body area 95 directly adjacent to the first cured main body area 91 and overlapping the partially cured shoulder area 92, the UV radiation source will pass over the second spot 94 and will subject it to high intensity radiation about 3 seconds after the second curing pass has begun. Accordingly, the time lapse between partially curing and completely curing the second spot 94 is at least about 6 seconds. In contrast, the UV radiation source will pass over the first spot 93 and will subject it to high intensity radiation from the UV radiation source at least about 57 seconds after beginning the second curing pass. The time lapse between partially curing and completely curing points along the shoulder area 92 may range from several seconds to two minutes. As shown in FIG. 9b, the second pass will create a second main body completely cured area 95 and a second partially cured shoulder area 96 despite the UV radiation source not passing over the shoulder area 96.

Consequently, the size of a coated surface and the speed at which a UV radiation source is passed over the coated surface will impact the time lapse between a shoulder area being partially cured by weak intensity radiation from a first curing pass and being completely cured by high intensity radiation from a second curing pass. For large surface areas, it is impractical to achieve complete two directly adjacent curing passes of the coating composition on the surface in less than about one minute. As a result, it is an advantage of coating compositions according to the present invention to prevent wrinkling or buckling of the partially cured coating located in the shoulder area adjacent to a main body area that has been fully cured by a first pass of a UV radiation source, for at least about one minute or until a second pass of the UV radiation source can be made to completely cure the shoulder area. In certain embodiments, the inventive coating compositions are free of wrinkles following subjection to weak intensity radiation for at least about 0.5 minutes, or at least about one minute, or at least about two minutes, or at least about five minutes, or at least about ten minutes, or at least about twenty minutes, or at least about thirty minutes, prior to being completely cured by subjection to high intensity radiation from a UV radiation source.

Experiments can be executed to determine the amount of time for wrinkles to form in a shoulder area. Referring again to FIG. 9a, a UV-curable coating composition can be applied to a small surface area 90 such as on a 4 inch×6 inch metal panel. Due to the small coating area, the test panel is placed on one side of the curing path so that when the curing machine passes over part of the test panel, the first main body area 91 on the test panel is directly under the curing machine. The amount of time can then be observed as to when wrinkles begin to form in the shoulder area 92, despite a UV radiation source not passing over the shoulder area 92. While experiments can be performed with coating on metal panels, the coating, in aspects of the invention, is applied to concrete floors or other substrates.

Despite various design modifications, it is not believed that there are any available UV radiation sources that provide a radiation cutoff from high intensity light to zero light (e.g., does not provide a leakage of weak radiation at the edges of the shielding of one or more lamps, bulbs, and/or LEDs of the UV radiation source). Aspects of the present invention, however, overcome the problem of wrinkle formation caused by low intensity light leakage by providing specific compositions of UV-curable coating formulations. Accordingly, the particular type or instrument model of the UV radiation source is not a significant factor in achieving wrinkle-free UV-cured coatings according to embodiments of the invention, and any conventional UV radiation source may be employed with aspects of the current invention.

Referring to FIG. 10, a cross-section of a clear coating 100 according to the prior art is illustrated. Clear coatings may be made up of more than one individual coating, such as a primer coating 102 applied directly to a surface (not shown) and a topcoat 104 applied on top of the primer. Typically, primer coatings are configured to provide adhesion of the UV-curable coatings to the surface, such as to a concrete surface. Topcoats are usually formulated to provide properties such as mechanical and chemical resistance and a desired level of gloss. Due to the problem of wrinkle formation, many prior art clear coating compositions could only be applied to large areas at a maximum thickness of about 0.13 mm (5 mils) without the formation of wrinkles during curing.

Clear coatings can include up to 0.5 weight % of a pigment or dye in the coatings for color tint purposes, and still be considered clear coatings because the coatings do not provide full hiding, i.e., the coatings remain transparent.

As noted above, the present invention provides a solution to the problem of wrinkle formation in clear UV-curable coating compositions such that coatings of up to about 0.64 mm (25 mils), or thicker, may be applied to large areas and cured via UV radiation without the generation of visible wrinkles.

An embodiment of the instant claimed invention is a radiation-curable coating composition for a floor comprising:

at least one multifunctional monomer or oligomer;

at least one photoinitiator;

at least one polymer; and

one or more tertiary amine compounds comprising zero or one acrylate crosslinkable double bonds.

UV-curable compositions according to certain embodiments of the invention comprise at least one monomer in the 100% solids compositions. In certain aspects, the at least one monomer is a reactive diluent monomer. Reactive diluent monomers are well known in the art of radiation curable coatings for optical fiber and many of the reactive diluent monomers that are present in radiation curable coatings for optical fiber are also used in radiation curable coatings for concrete and wood floors. See pages 105 of the article entitled “Optical Fiber Coatings” by Steven R. Schmid and Anthony F. Toussaint, DSM Desotech, Elgin, Ill., Chapter 4 of Specialty Optical Fibers Handbook, edited by Alexis Mendez and T. F. Morse, ©2007 by Elsevier Inc., for a succinct summary of these types of reactive diluent monomers.

In embodiments of the invention, suitable monomers for the UV-curable compositions include for example and without limitation, monomers typically employed in the art of radiation-curable compositions and known by persons skilled in the art. In embodiments of the invention, the one or more monomers are included in an amount of between about 5% and about 90% by weight, or about 10% and about 80%, or about 20% and about 70%, or about 30% and about 60%, or about 40% and about 50% by weight of the total UV-curable composition. In certain aspects of the invention, the monomers comprise a viscosity of equal to or greater than 20 centipoises.

Oligomers suitable for use in the compositions of the instant claimed invention include any oligomer that is already known to be radiation curable. Such oligomers include, but are not limited to: urethane acrylate oligomers, aliphatic urethane acrylate oligomers such as Neorad U-10, available from DSM and aromatic monoacrylate oligomers, such as CN131B, available from Sartomer.

UV-curable compositions according to the invention comprise at least one photoinitiator to initiate the polymerization reaction upon absorption of UV radiation. Photoinitiators and stabilizers are described in the reference text MODERN COATING TECHNOLOGY cited above, on pages 29-34. In general, free radical photoinitiators are well known in the art of radiation curable coatings. See pages 105 of the article entitled “Optical Fiber Coatings” by Steven R. Schmid and Anthony F. Toussaint, DSM Desotech, Elgin, Ill., Chapter 4 of Specialty Optical Fibers Handbook, edited by Alexis Mendez and T. F. Morse, ©2007 by Elsevier Inc., for a succinct summary of these types of photoinitiators.

Typically, free radical photoinitiators are divided into those that form radicals by cleavage, known as “Norrish Type I” and those that form radicals by hydrogen abstraction, known as “Norrish Type II”. As discussed above, tertiary amine compounds have been known to be used as synergists in conjunction with Norrish Type II photoinitiators. Although certain embodiments of the invention comprise Norrish Type II photoinitiators in the UV-curable composition formulation, synergy between a Norrish Type II photoinitiator and a tertiary amine compound is not necessary for the instant invention. Indeed, embodiments of UV-curable coating compositions of the current invention comprise Norrish Type I photoinitiators, which generate free radicals via a fragmentation process (e.g., via cleavage). Any suitable Norrish Type I photoinitiator may be employed, for example and without limitation, a photoinitiator selected from the group consisting of acyl phosphine oxides, benzoin ethers, 2,2-diethoxyacetophenone, benzyl dimethylketal, 1-hydroxycyclohexylphenyl-ketone, 1-hydroxycyclohexyl benzophenone, 2-hydroxy-2-methyl propiophenone, 2-ethoxy-2-isobutoxyacetophenone, 2,2-dimethyl-2-hydroxyacetophenone, 2,2-dimethoxy-2-phenylacetophenone, 2,2,2-trichloro-4-t-butylacetophenone, 2,2-dimethyl-2-hydroxy-4-t-butylacetophenone, 1-phenyl-1,2-propanedione-2-O-ethoxycarbonyl ester, 1-phenyl-1,2-propanedione-2-O-benzoyl oxime, and combinations thereof. For embodiments comprising Norrish Type II photoinitiators, any suitable Type II photoinitiator as typically known in the art may be employed in the inventive UV-curable compositions. Photoinitiators are included in embodiments of the UV-curable compositions at any suitable amount, for example and without limitation, between about 0.1% and about 5% by weight, between about 1% and about 4% by weight, or about 3% by weight of the total composition.

It was unexpectedly discovered that the addition of polymers to the coating composition assists in preventing, decreasing or delaying the formation of wrinkles. Cured coatings that included polymers exhibited significant wrinkle-resistant properties in terms of wrinkle thickness and/or wrinkle delay time. It also was unexpectedly discovered that increasing the amount of polymer in the coating composition increases the amount of time for wrinkles to form in the coating and may prevent the formation of wrinkles. Examples 1 and 4 show that where the amount of polymer in the coating composition increases, the wrinkle resistant properties of the coating increases.

Suitable polymers for inclusion in radiation-curable compositions according to embodiments of the invention include polymers with no cross-linkable double bonds and polymers comprising crosslinkable double bonds. The preferred polymers are polymers with no cross-linkable double bonds. Suitable polymers include for example and without limitation polyesters, acrylate (co)polymers, methacrylate (co)polymers, cellulose acetate butyrate, vinyl acetate (co)polymers and combinations thereof.

In certain embodiments of the invention non-reactive polymers for inclusion in the compositions have a lower limit of the number average molecular weight, Mn, of 5,000 grams per mol and reactive polymers have a lower limit of the number average molecular weight, Mn, of 10,000 grams per mole. UV-curable compositions according to certain embodiments of the invention comprise non-reactive polymer in the compositions. One or more non-reactive polymers are included in certain embodiments of the invention in an amount of between about 5% and about 60% by weight, or about 10% and about 50%, or about 20% and about 40%, or about 30% by weight of the total UV-curable composition. In addition, in certain embodiments, reactive polymers are included in an amount of between about 5% and about 60% by weight, or about 10% and about 50%, or about 20% and about 40%, or about 30% by weight of the total UV-curable composition.

It was unexpectedly discovered that the addition of tertiary amines assists in preventing, limiting or delaying the formation of wrinkles during curing. Clear coatings with tertiary amines appear continuous across a plurality of portions that were cured in separate passes of the UV radiation source. The amine value of a particular tertiary amine sample is expressed as the number of milligrams of potassium hydroxide equivalent to the amine basicity in 1 g of the sample.

It also was unexpectedly discovered that increasing the amount of tertiary amine in the coating composition increases the wrinkle-resistant characteristics of the composition by increasing the amount of time it takes for a wrinkle to form or preventing wrinkles from forming. As is described below in Examples 1 and 2, increasing the tertiary amine value of a coating composition from 7.5 to 15 milligrams KOH per gram of the total radiation-curable resins in the composition significantly increases the wrinkle-resistant characteristic of the composition. In Example 1 the coating composition with 15 milligrams KOH per gram of the total radiation-curable resins in the composition does not form wrinkles after 10 minutes; in Example 2 the coating composition with 7.5 milligrams KOH per gram of the total radiation-curable resins in the composition exhibits wrinkle formation 5 minutes after the first pass of the UV radiation source.

Tertiary amine compounds have been employed as peroxide scavengers for overcoming oxygen inhibition of polymerization at the coating surface of UV-curable coatings, plus as synergists for Norrish Type II photoinitiators (i.e., photoinitiators that form an active species by a hydrogen abstraction process). However, it is not believed that there has been any investigation into the effects of tertiary amines on polymerization at extremely low radiation intensities such as the stray light condition disclosed in this application. In fact, the amount of radiation provided by light leakage from UV radiation sources is not even above the minimum detectable level of a typical dosimeter, which is about 5-10 mW/cm². Without wishing to be bound by theory, it is hypothesized that at such low levels of radiation intensity, the small amounts of dissolved oxygen throughout the coating inhibit the photoinitiated polymerization reaction, thus the inclusion of a chain transfer agent, in particular one or more tertiary amine compounds, assists to partially cure enough thickness of the coating from the surface down to prevent wrinkling of this thick skin layer for up to about twenty minutes. In certain aspects, wrinkling is prevented completely regardless of the waiting time.

Suitable tertiary amine compounds include tertiary amine compounds comprising zero or one crosslinkable double bonds, for instance acrylate double bonds, which may also be referred to as “acrylate functionality”. Suitable tertiary amine compounds also include the salts of such compounds. Acrylated amines are commonly preferred over the non acrylated amines due to their advantages of low odor, low extractables, and improved yellowing as compared to the non acrylated amines. When non acrylated amines are employed, it is typically in a low amount, such as less than an amount sufficient to provide an amine value of 7.5 milligrams KOH per gram of the total amount of radiation-curable resins of the radiation-curable composition. Surprisingly, tertiary amine compounds having high acrylate functionality, i.e., comprising two or more crosslinkable double bonds, were not effective at preventing wrinkle formation for about one to about twenty minutes between passes of the UV radiation source. This is unexpected at least because the level of acrylate functionality is not supposed to affect a particular tertiary amine compound's effect on oxygen inhibition during polymerization.

Suitable tertiary amine compounds include some commercially available compounds and mixtures, for example and without limitation CN 386, CN 383 and CN 384, which are each available from Sartomer Company, Inc. (Exton, Pa.), and Ebecryl® P115, available from Cytec Industries Inc. (Woodland Park, N.J.). CN 386, CN 384 and CN 383 are tertiary amines, marketed by Sartomer Company, Inc. as difunctional amine coinitiators for use in conjunction with a photosensitizer such as benzophenone to promote rapid curing under UV radiation. CN383 is a non acrylated amine monomer with zero crosslinkable double bonds. CN384 is an amine acrylate monomer with one crosslinkable double bond. CN386 is a non acrylated amine monomer with zero crosslinkable double bonds. Ebecryl® P115 is a copolymerizable amine marketed by Cytec Industries Inc. as a hydrogen donor, or photoactivator with no acrylate functionality, in UV-curable coatings, optionally in combination with a photosensitizer. Additional suitable tertiary amine compounds for certain embodiments of the invention include for example and without limitation tertiary amine compounds selected from the group consisting of triethylamine, triethanolamine, N,N-dimethyl-p-toluidine, methyl diethanolamine, dimethyl ethanol-amine, 2-n-butoxyethyl-4-dimethylaminobenzoate, 2-ethyl-p-(N,N-dimethylamino) benzoate, 2-ethylhexyl-p-dimethylaminobenzoate.

In embodiments of the invention, one or more tertiary amine compounds are used in amounts sufficient to provide an amine value of at least 7.5 milligrams KOH per gram of the total amount of radiation-curable resins of the radiation-curable composition. In certain aspects, the one or more tertiary amine compounds are included in an amount sufficient to provide an amine value of at least 9 milligrams, or at least 12 milligrams, or at least 15 milligrams, or at least 20 milligrams, or at least 40 milligrams KOH per gram of the total amount of resins of the radiation-curable composition and excludes components such as inorganic fillers. The amount of the one or more tertiary amine compounds will also depend on the rest of the components present in the UV-curable composition.

In embodiments of the invention, the one or more tertiary amine compounds equal at least 5 weight % of the total amount of the radiation-curable composition. In certain aspects, the one or more tertiary amine compounds are included in an amounts equal to at least 10 weight %, at least 13 weight %, at least 15 weight %, or at least 20 weight %, of the total amount of the radiation-curable composition. The tertiary amine compounds, as discussed previously, include the salts thereof.

UV-curable compositions according to certain embodiments of the invention comprise at least one filler component. Suitable fillers include materials that have no significant absorption to visible light radiation (i.e., wavelengths longer than about 400 nm) and at least a portion of UV light radiation (i.e., wavelengths between about 250 nm and about 400 nm). Such suitable fillers according to aspects of the invention are for example and without limitation, fillers selected from the group consisting of any types of silica oxide particles, silicate particles, ceramic particles, clay particles, calcium carbonate particles, aluminum oxide particles, aluminum hydroxide particles, calcium sulfate particles, barium sulfate particles, hollow glass beads, solid glass beads, glass fibers, glass flakes, polymeric particles such as acrylic particles, polyolefin particles, silicon particles and the like, and combinations thereof. For example, ceramic microspheres are commercially available from 3M (St. Paul, Minn.), and Sphericel® hollow glass spheres are commercially available from Potters Industries Inc. (Valley Forge, Pa.). In certain aspects, the average particle size of the fillers comprises 300 microns or less in at least one dimension.

Without wishing to be bound by theory, it is hypothesized that the filler particles scatter weak light present within the coating composition to assist in driving the polymerization reaction to completion. One or more fillers may be present in UV-curable compositions in an amount of between about 1% and about 70% by weight, or between about 5% and about 60%, or between about 10% and about 50%, or between about 15% and about 40%, or between about 20% and about 30%, or between about 10% and about 20% by weight of the total UV-curable composition. In certain embodiments of the present invention, both tertiary amine compounds and fillers are included in UV-curable compositions to provide synergistically enhanced curing of the compositions without the formation of visible wrinkles.

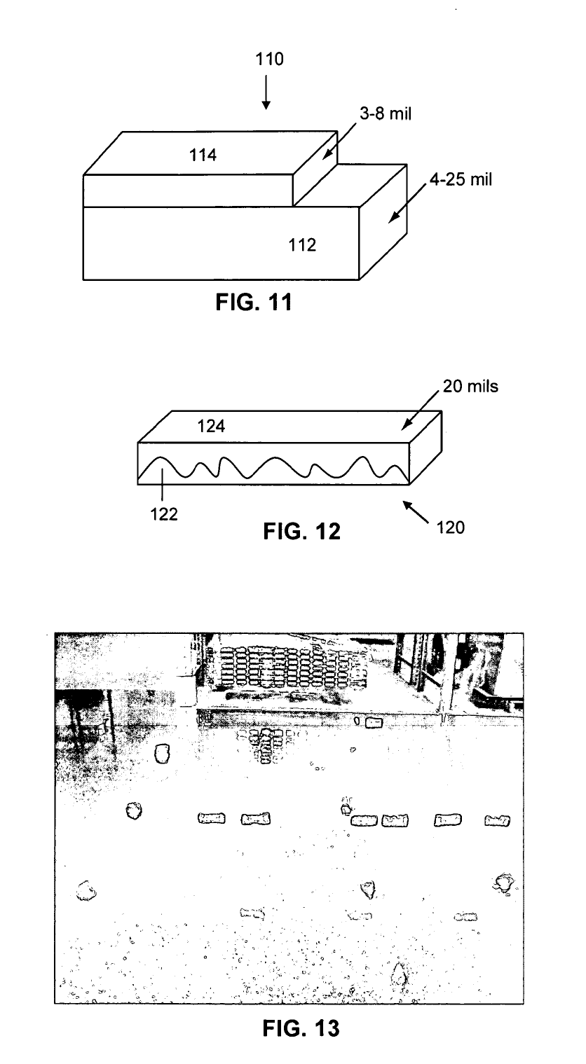

In certain embodiments, the UV-curable composition comprises a topcoat, such as a clear topcoat for concrete. Such topcoats are applied on top of primer coats. Referring to FIG. 11, a cross-section of a clear coating 110 according to an embodiment of the invention is illustrated. Clear coatings 110 may be made up of more than one individual coating, such as a primer coat 112 applied directly to a surface (not shown) and a topcoat 114 applied on top of the primer coat 112. Typically, primer coats are configured to provide adhesion of the UV-curable coatings to the surface, such as to a concrete surface. Topcoats are usually formulated to provide properties such as mechanical and chemical resistance and a desired level of gloss. Due to the advantages of inventive formulations of UV-curable coating compositions, clear coating compositions according to certain aspects of the invention can be applied to large areas at a thickness of at least 0.15 mm (6 mils) for the primer coat or the topcoat without the formation of wrinkles during curing. According to additional embodiments of the invention, UV-curable coating compositions can be applied as primer coatings or topcoat coatings to large areas at a thickness of at least about 0.18 mm (7 mils), or at least about 0.20 mm (8 mils), or at least about 023 mm (9 mils), or at least about 0.25 mm (10 mils), or at least about 0.28 mm (11 mils), or at least about 0.30 mm (12 mils), or at least about 0.33 mm (13 mils), or at least about 0.38 mm (14 mils), or at least about 0.39 mm (15 mils), or at least about 0.40 mm (16 mils), or at least about 0.43 mm (17 mils), or at least about 0.46 mm (18 mils), or at least about 0.48 mm (19 mils), or at least about 0.51 mm (20 mils), or at least about 0.53 mm (21 mils), or at least about 0.56 mm (22 mils), or at least about 0.58 mm (23 mils), or at least about 0.61 mm (24 mils), or at least about 0.64 mm (25 mils), without the formation of wrinkles during curing where the time lapse between the directly adjacent curing passes is at least two minutes.

In certain embodiments, the UV-curable composition comprises a primer coat composition, such as a clear primer coat composition for concrete. Such primer coat compositions are applied directly to clean surfaces to provide good adhesion of the coating to the particular surface, such as concrete. The surface may be cleaned according to methods commonly used in the art of surface coating, wherein the cleaning comprises removing debris and optionally coatings adhered to the surface. In alternate embodiments, the primer coating composition is applied directly to substrates such as wood, vinyl, composite materials, and the like. One advantage of the invention is the ability to apply thick coatings of the UV-curable composition. For instance, FIG. 12 illustrates a cross-section of a coated concrete substrate 120 surface that comprises a rough surface 122 as a result of being shot blasted to remove prior coatings and/or debris from the concrete surface. A coating 124 of a UV-curable composition according to an embodiment of the invention is disposed on the rough concrete surface 122, the coating 124 having a thickness of about 0.51 mm (20 mils).

Aspects of the inventive UV-curable compositions allow for a high build clear coating composition to be applied to a surface having a thickness of at least about 0.25 mm (10 mils), or at least about 0.38 mm (14 mils), or at least about 0.46 mm (18 mils), or at least about 0.51 mm (20 mils), or at least about 0.56 mm (22 mils), such as up to about 0.64 mm (25 mils). High build clear coatings on surfaces having an area with at least one dimension greater than the width of a UV radiation source are capable of being cured using UV radiation in more than one pass of the UV radiation source having a time lapse of between about one and about twenty minutes between passes, while remaining wrinkle-fee. For instance, clear primer coat compositions are applied in certain embodiments at a thickness of at least about 6 mils, or at least about 0.30 mm (12 mils), or at least about 0.46 mm (18 mils), or at least about 0.61 mm (24 mils) thick.

FIG. 13 illustrates a clear coating system with 0.25 mm (10 mil) primer and 0.20 mm (8 mil) topcoat coatings according to an embodiment of the invention, applied to a concrete floor having an area of over 18.58 square meters (200 square feet). The clear coating composition was cured using a UV radiation source having a width of 0.66 m (26 inches). The photograph of the cured coating in FIG. 13 demonstrates that the UV-curable coating is free of wrinkles in spite of the use of multiple passes of the UV radiation source over the uncured coating composition. The coating composition was cured using a HID Hammerhead UV Floor Curing Equipment model 26-8000A, as shown in FIG. 6, having 8000 watts and powered at 208/240 volts, 60 hertz, 45 amps, with an automatic propulsion cure speed of about 7.62 m (25 feet) per minute.

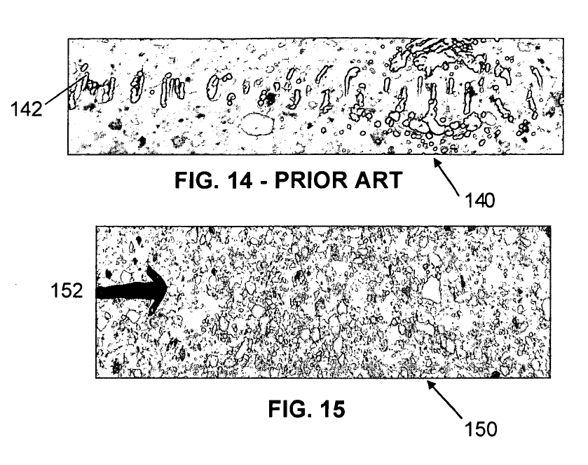

In contrast to the inventive coatings, a prior art clear cured coating, having the composition disclosed below in Comparative Example 10, is shown in FIG. 14. The prior art clear coating was applied to a concrete surface at a thickness of 0.25 mm (10 mils) and was cured using two passes of a UV radiation source, with a delay of about 1 minute between the two passes. The wrinkle 142 that formed in the coating 140 after the first curing pass is visible. In comparison to the prior art coating which comprises severe wrinkling at an application thickness of 0.25 mm (10 mils) within about 1 minute as shown in FIG. 14, the photograph of the cured coating in FIG. 15 demonstrates that an inventive clear UV-curable coating is free of wrinkles or buckles in spite of the use of more than one pass of the UV radiation source over the uncured coating composition. The coating composition 140 was applied to a concrete surface at a wet thickness of 0.25 mm (10 mils), and the second cure pass was performed about 10 minutes after the first cure pass. The arrow position 142 indicates where the shoulder area was located following the first pass. Clearly, there are no visible wrinkles, buckles or gloss lines located in the shoulder area shown in the close-up photograph of the cured coating composition.

According to the invention, a UV-curable coating composition is provided comprising at least one multifunctional monomer or oligomer, at least one photoinitiator, at least one polymer, and one or more tertiary amine compounds, such as in an amount that provides an amine value of at least 7.5 milligrams KOH per gram of the total radiation-curable resins of the radiation-curable composition. In other embodiments, the one or more tertiary amines are provided in an amount comprising an amine value of at least 9 milligrams KOH per gram of the total radiation-curable resins in the coating composition.

In an embodiment of the current invention, a method is provided for coating a concrete floor comprising applying a coating composition over a predetermined area of a surface of a concrete floor, wherein the coating composition comprises at least one multifunctional monomer or oligomer, at least one photoinitiator, at least one polymer, and one or more tertiary amine compounds comprising zero or one crosslinkable double bonds and wherein the coating composition comprises a thickness of at least 0.15 mm (6 mils) on the surface. In other embodiments, the one or more tertiary amines are provided in an amount comprising an amine value of at least 9 milligrams KOH per gram of the total radiation-curable resins in the coating composition. The method further comprises passing a UV radiation source over a first portion of the predetermined area of the surface to cure the coating composition, the first portion comprising a main body area in an initial pass. A shoulder area which is directly adjacent to the main body area does not have the UV radiation source pass over it in the initial pass but is partially cured by the stray light leaked from the edge of the light shield. Then, the UV radiation source is passed over a second portion of the predetermined area of the surface to cure the coating composition, wherein the second portion includes the shoulder area directly adjacent the first portion. The shoulder area in some embodiments has a width of at least about half of a centimeter, at least about one centimeter, at least about 5 centimeters, or at least about 10 centimeters. The passing over the second portion finishes at least about one minute after the passing over the first portion begins; in some embodiments, the passing over the second portion finishes at least about two minutes, or at least about five minutes, or at least about ten minutes, or at least about twenty minutes, or at least about thirty minutes after the passing over the first portion begins. The shoulder area is not visible following the passing of the UV radiation source over the second portion, for example the shoulder area directly adjacent the first portion is planar and/or free of wrinkles and/or buckles following the passing of the UV radiation source over the second portion.

The passing of the UV radiation source according to embodiments of the invention occurs at a rate of between about 4.57 m (15 feet) per minute and about 15.24 in (50 feet) per minute, such as between about 6.10 m (20 feet) per minute and 12.20 m (40 feet) per minute, for instance about 7.62 m (25 feet) per minute. For a coated surface comprising a length of 30.48 m (100 feet), it would take at least about 8 minutes to complete two full passes of the UV radiation source at a pass rate of about 7.62 m (25 feet) per minute, back and forth along the length of the surface, in order to cure two directly adjacent portions of the coated surface. Similarly, for a coated surface comprising a length of 60.10 m (200 feet), it would take at least about 10 minutes to complete two full passes of the radiation source at a pass rate of about 12.20 m (40 feet) per minute, back and forth along the length of the surface, in order to cure two directly adjacent portions of the coated surface. Consequently, the current invention allows surface areas comprising a length of from at least about 12.20 m (40 feet) to about 122 in (400 feet) to be coated to a thickness of at least about 0.15 mm (6 mils) and cured at a UV radiation source pass rate of between about 4.57 m per minute and about 15.24 in per minute (15 and about 50 feet), without forming visible wrinkles in the coating.

In an embodiment of the current invention, a coated concrete floor is provided comprising a surface and a coating composition applied to the surface. The coating composition comprises at least one multifunctional monomer or oligomer, at least one photoinitiator, at least one polymer and one or more tertiary amine compounds comprising zero or one acrylate double bonds, wherein the coating composition has a thickness of at least 0.15 mm (6 mils). In other embodiments, the one or more tertiary amines are provided in an amount comprising an amine value of at least 7.5 milligrams potassium hydroxide KOH per gram of the total UV-curable resins in the coating composition.

In an embodiment of the current invention, a coated concrete floor is provided coated by the method comprising applying a coating composition over a predetermined area of a surface of a concrete floor, the coating composition comprising at least one multifunctional monomer or oligomer, at least one photoinitiator, at least one polymer, and one or more tertiary amine compounds comprising zero or one acrylate double bonds, wherein the cured coating composition comprises a thickness of at least 0.15 mm (6 mils). In other embodiments, the one or more tertiary amines are provided in an amount comprising an amine value of at least 7.5 milligrams KOH per gram of the total UV-curable resins in the coating composition. The method further comprises passing a UV radiation source over a first portion of the predetermined area of the surface to cure the coating composition, the first portion comprising a main body area in a first pass. The UV radiation source does not pass over a shoulder area directly adjacent to the main body area during the first pass but has stray light leaked from the edge of the light shield partially curing the coating at the shoulder area. Then the UV radiation source is passed over a second portion of the predetermined area of the surface to cure the coating composition, the second portion includes the shoulder area directly adjacent the first portion. The passing over the second portion finishes at least about one minute after the passing over the first portion begins, and the shoulder area directly adjacent the first portion is planar and/or free of wrinkles and/or buckles following the passing of the UV radiation source over the second portion.

### EXAMPLES

The following examples are illustrative of embodiments of the present invention, as described above, and are not meant to limit the invention in any way.

### Example 1

A radiation-curable composition comprising a combination of a tertiary amine compound having zero crosslinkable double bonds providing an amine value of 15.0 milligrams KOH per gram of the total radiation-curable resins in the composition, a urethane acrylate oligomer, a polymer, acrylate monomers, and photoinitiators, successfully provides a UV-curable composition that is free of wrinkles upon curing of more than one directly adjacent section of a coated surface. The UV-curable coating comprises the materials provided in Table 1 below. The weight percent of the tertiary amine compounds and the weight percent of polymer in the Examples are provided for comparative purposes.

A UV-curable coating is prepared comprising the materials listed in Table 1, then applied as a primer coat to a 10.16 cm×15.24 cm (4 inch×6 inch) metal substrate, to a thickness of 0.25 mm (10 mils). Next, one portion of the 0.25 mm (10 mil) thick coating is cured using a HID Hammerhead UV Floor Curing Equipment model 26-8000A (as shown in FIG. 6) as the UV radiation source. The HID Hammerhead machine provides 8000 watts and is powered at 208/240 volts, 60 hertz, 45 amps, with an automatic propulsion cure speed of about 7.62 m (25 feet) per minute. Following curing of the first pass, observation of the clear primer coat at the shoulder area (e.g., curing edge) shows no visible wrinkles for at least about 10 minutes before curing the next pass.

TABLE 1

| Product | Chemical Type | Amount (wt %) |
|---|---|---|
| CN 820 | acrylic polymer (70%-80%) dissolved in | 27% |
| | acrylate monomer (20%-30%) | |
| SR 306 | tripropylene glycol diacrylate monomer | 13.5% |
| SR 454 | ethoxylated (3) trimethyl propane | 13.5% |
| | triacrylate monomer | |
| SR 833 | tricyclodecane dimethanol diacrylate | 12.6% |
| | monomer | |
| CN 383 | tertiary amine with zero crosslinkable | 10% |
| | double bonds | |
| SR 399 | dipentaerythritol pentaacrylate monomer | 9% |
| Neorad U-10 | aliphatic urethane acrylate oligomers | 9% |
| Irgacure 184 | 1-hydroxycyclohexyl benzophenone | 2.7% |
| Darocure 1173 | 2-hydroxy-2-methyl propiophenone | 2.7% |
| | Total: | 100% |

### Example 2

A radiation-curable composition similar to the composition in Example 1, but containing 5 weight percent tertiary amine compound with zero crosslinkable double bonds rather than 10 weight percent of such compound, exhibits wrinkles in the coating within less than ten minutes. The tertiary amine compound provides an amine value of 7.5 mg potassium hydroxide (KOH) per gram of the total radiation-curable resins of the coating composition. The UV-curable coating comprises the materials provided in Table 2 below. A UV-curable coating is prepared comprising the materials listed in Table 2, then applied as a primer coat to a 4 inch×6 inch metal substrate, to a thickness of 0.25 mm (10 mils). Next, the 0.25 mm (10 mil) thick coating is cured according to the method described in Example 1. Following curing of the first pass, observation of the clear primer coat at the shoulder area starts to show visible wrinkles at 5 minutes.

TABLE 2

| Product | Chemical Type | Amount (wt %) |
|---|---|---|
| CN 820 | acrylic polymer (70%-80%) dissolved in | 28.5% |
| | acrylate monomer (20%-30%) | |
| SR 306 | tripropylene glycol diacrylate monomer | 14.25% |
| SR 454 | ethoxylated (3) trimethyl propane | 14.25% |
| | triacrylate monomer | |
| SR 833 | tricyclodecane dimethanol diacrylate | 13.3% |
| | monomer | |
| CN 383 | tertiary amine with zero crosslinkable | 5.0% |
| | double bonds | |
| SR 399 | dipentaerythritol pentaacrylate monomer | 9.5% |
| Neorad U-10 | aliphatic urethane acrylate oligomers | 9.5% |
| Irgacure 184 | 1-hydroxycyclohexyl benzophenone | 2.85% |
| Darocure 1173 | 2-hydroxy-2-methyl propiophenone | 2.85% |
| | Total: | 100% |

### Example 3

A radiation-curable composition similar to the composition in Example 1, but containing an acrylated functional acrylic polymer (CN 816) rather than non acrylated acrylic polymer (70%-80%) dissolved in acrylate monomer (20%-30%) exhibits no wrinkles 10 minutes after curing of a first pass, similar to Example 1. The amine acrylate monomer provides an amine value of 15 mg potassium hydroxide (KOH) per gram of the total radiation-curable resins of the coating composition. The UV-curable coating comprises the materials provided in Table 3 below. A UV-curable coating is prepared comprising the materials listed in Table 3, then applied as a primer coat to a 10.16 cm×15.24 cm (4 inch×6 inch) metal substrate, to a thickness of 0.25 mm (10 mils). Next, the 0.25 mm (10 mil) thick coating is cured according to the method described in Example 1. Following curing of the first pass, observation of the clear primer coat at the shoulder area shows no visible wrinkles for at least about 10 minutes before curing the next pass.

TABLE 3

| Product | Chemical Type | Amount (wt %) |
|---|---|---|
| CN 816 | Acrylated acrylic polymer (70%-80%) | 27.0% |
| | dissolved in acrylate monomer | |
| | (20%-30%) | |
| SR 306 | tripropylene glycol diacrylate monomer | 13.5% |
| SR 454 | ethoxylated (3) trimethyl propane | 13.5% |
| | triacrylate monomer | |
| SR 833 | tricyclodecane dimethanol diacrylate | 12.6% |
| | monomer | |
| CN 383 | tertiary amine with zero crosslinkable | 10.0% |
| | double bonds | |
| SR 399 | dipentaerythritol pentaacrylate monomer | 9.0% |
| Neorad U-10 | aliphatic urethane acrylate oligomers | 9.0% |
| Irgacure 184 | 1-hydroxycyclohexyl benzophenone | 2.7% |
| Darocure 1173 | 2-hydroxy-2-methyl propiophenone | 2.7% |
| | Total: | 100% |

### Example 4

A radiation-curable composition similar to the composition in Example 1, but containing about 5 weight percent acrylic polymer (i.e., 7.1 weight percent acrylic polymer solution in acrylate monomer assuming 70% concentration of polymer), exhibits wrinkles in the coating at a faster rate than the composition in Example 1. The amine acrylate monomer provides an amine value of 19.5 mg potassium hydroxide (KOH) per gram of the total radiation-curable resins of the coating composition. The UV-curable coating comprises the materials provided in Table 4 below. A UV-curable coating is prepared comprising the materials listed in Table 4, then applied as a primer coat to a 10.16 cm×15.24 cm (4 inch×6 inch) metal substrate, to a thickness of 0.25 mm (10 mils). Next, the 0.25 mm (10 mil) thick coating is cured according to the method described in Example 1. Following curing of the first pass, observation of the clear primer coat at the shoulder area starts to show wrinkles at 6 minutes.

TABLE 4

| Product | Chemical Type | Amount (wt %) |
|---|---|---|
| CN 820 | acrylic polymer (70-80%) dissolved in | 7.1% |
| | acrylate monomer (20-30%) | |
| SR 306 | tripropylene glycol diacrylate monomer | 17.5% |
| SR 454 | ethoxylated (3) trimethyl propane | 17.5% |
| | triacrylate monomer | |
| SR 833 | tricyclodecane dimethanol diacrylate | 16.3% |
| | monomer | |
| CN 383 | tertiary amine with zero crosslinkable | 13.0% |
| | double bonds | |
| SR 399 | dipentaerythritol pentaacrylate monomer | 11.6% |
| Neorad U-10 | aliphatic urethane acrylate oligomers | 11.6% |
| Irgacure 184 | 1-hydroxycyclohexyl benzophenone | 2.7% |
| Darocure 1173 | 2-hydroxy-2-methyl propiophenone | 2.7% |
| | Total: | 100% |

### Example 5

A radiation-curable composition comprising a combination of a tertiary amine compound having one crosslinkable double bond and an amine value of 14.6 milligrams KOH per gram of the total radiation-curable resins in the composition, a urethane acrylate oligomer, a polymer, acrylate monomers, and photoinitiators, successfully provides a UV-curable composition that is free of wrinkles upon curing of more than one directly adjacent section of a coated surface. The UV-curable coating comprises the materials provided in Table 5 below. A UV-curable coating is prepared comprising the materials listed in Table 5, then applied as a primer coating to a 10.16 cm×15.24 cm (4 inch×6 inch) metal substrate, to a thickness of 0.25 mm (10 mils). Next, the 0.25 mm (10 mil) thick coating is cured according to the method described in Example 1. Following curing of the first pass, observation of the clear primer coat at the shoulder area shows no visible wrinkles for at least about 10 minutes before curing the next pass.

TABLE 5

| Product | Chemical Type | Amount (wt %) |
|---|---|---|
| CN 820 | acrylic polymer (70%-80%) dissolved in | 26% |
| | acrylate monomer (20%-30%) | |
| SR 306 | tripropylene glycol diacrylate monomer | 13.1% |
| SR 454 | ethoxylated (3) trimethyl propane | 13.1% |
| | triacrylate monomer | |
| SR 833 | tricyclodecane dimethanol diacrylate | 12.2% |
| | monomer | |
| CN 384 | amine acrylate monomer with one | 13% |
| | crosslinkable double bond | |
| SR 399 | dipentaerythritol pentaacrylate monomer | 8.7% |
| Neorad U-10 | aliphatic urethane acrylate oligomers | 8.7% |
| Irgacure 184 | 1-hydroxycyclohexyl benzophenone | 2.6% |
| Darocure 1173 | 2-hydroxy-2-methyl propiophenone | 2.6% |
| | Total: | 100% |

### Example 6

A radiation-curable composition comprising a combination of a tertiary amine compound having zero crosslinkable double bonds and an amine value of 15.1 milligrams KOH per gram of the total radiation-curable resins in the composition, a urethane oligomer, a polymer, acrylate monomers, and photoinitiators, successfully provides a UV-curable composition that is free of wrinkles upon curing of more than one directly adjacent section of a coated surface. The UV-curable coating comprises the materials provided in Table 6 below. A UV-curable coating is prepared comprising the materials listed in Table 6, then applied as a primer coating to a 10.16 cm×15.24 cm (4 inch×6 inch) metal substrate, to a thickness of 0.25 mm (10 mils). Next, the 0.25 mm (10 mil) thick coating is cured according to the method described in Example 1. Following curing of the first pass, observation of the clear primer coat at the shoulder area shows no visible wrinkles for at least about 10 minutes before curing the next pass.

TABLE 6

| Product | Chemical Type | Amount (wt %) |
|---|---|---|
| CN 820 | acrylic polymer (70%-80%) dissolved in | 28% |
| | acrylate monomer (20%-30%) | |
| SR 306 | tripropylene glycol diacrylate monomer | 13.9% |
| SR 454 | ethoxylated (3) trimethyl propane | 13.9% |
| | triacrylate monomer | |
| SR 833 | tricyclodecane dimethanol diacrylate | 13% |
| | monomer | |
| CN 386 | tertiary amine with no crosslinkable | 7% |
| | double bonds | |
| SR 399 | dipentaerythritol pentaacrylate monomer | 9.3% |
| Neorad U-10 | aliphatic urethane acrylate oligomers | 9.3% |
| Irgacure 184 | 1-hydroxycyclohexyl benzophenone | 2.8% |
| Darocure 1173 | 2-hydroxy-2-methyl propiophenone | 2.8% |
| | Total: | 100% |

### Comparative Example 7

### Not an Example of the Instant Claimed Invention

A radiation-curable composition comprising a combination of a tertiary amine compound having two crosslinkable double bonds and an amine value of 15.1 milligrams KOH per gram of the total radiation-curable resins in the composition, a urethane acrylate oligomer, a polymer, acrylate monomers, and photoinitiators, does not provide a UV-curable composition that is free of wrinkles upon curing of more than one directly adjacent section of a coated surface. The UV-curable coating comprises the materials provided in Table 7 below. A UV-curable coating is prepared comprising the materials listed in Table 7, then applied as a primer coat to a 10.16 cm×15.24 cm (4 inch×6 inch) metal substrate, to a thickness of 0.25 mm (10 mils). Next, the 0.25 mm (10 mil) thick coating is cured according to the method described in Example 1. Following curing of the first pass, observation of the clear primer coat at the shoulder area shows visible wrinkles within less than about one minute.

TABLE 7
Comparative Example - Not an example of the instant claimed invention

| Product | Chemical Type | Amount (wt %) |
|---|---|---|
| CN 820 | acrylic polymer (70%-80%) dissolved in | 26.6% |
| | acrylate monomer (20%-30%) | |
| SR 306 | tripropylene glycol diacrylate monomer | 13.4% |
| SR 454 | ethoxylated (3) trimethyl propane | 13.4% |
| | triacrylate monomer | |
| SR 833 | tricyclodecane dimethanol diacrylate | 12.4% |
| | monomer | |
| CN 371 | amine acrylate monomer (with two | 11% |
| | crosslinkable double bonds) | |
| SR 399 | dipentaerythritol pentaacrylate monomer | 8.9% |
| Neorad U-10 | aliphatic urethane acrylate oligomers | 8.9% |
| Irgacure 184 | 1-hydroxycyclohexyl benzophenone | 2.7% |
| Darocure 1173 | 2-hydroxy-2-methyl propiophenone | 2.7% |
| | Total: | 100% |

### Comparative Example 8

### Not an Example of the Instant Claimed Invention

A radiation-curable composition comprising a combination of a tertiary amine compound having two crosslinkable double bonds and an amine value of 15.0 milligrams KOH per gram of the total radiation-curable resins in the composition, a urethane acrylate oligomer, a polymer, acrylate monomers, and photoinitiators, does not provide a UV-curable composition that is free of wrinkles upon curing of more than one directly adjacent section of a coated surface. The UV-curable coating comprises the materials provided in Table 8 below. A UV-curable coating is prepared comprising the materials listed in Table 8, then applied as a primer coating to a 10.16 cm×15.24 cm (4 inch×6 inch) metal substrate, to a thickness of 0.25 mm (10 mils). Next, the 0.25 mm (10 mil) thick coating is cured according to the method described in Example 1. Following curing of the first pass, observation of the cured clear primer coating instantly, or at least within less than about one minute, shows visible wrinkles.

TABLE 8
Comparative Example - Not an example of the instant claimed invention

| Product | Chemical Type | Amount (wt %) |
|---|---|---|
| CN 820 | acrylic polymer (70%-80%) dissolved in | 28.2% |
| | acrylate monomer (20%-30%) | |
| SR 306 | tripropylene glycol diacrylate monomer | 14.1% |
| SR 454 | ethoxylated (3) trimethyl propane | 14.1% |
| | triacrylate monomer | |
| SR 833 | tricyclodecane dimethanol diacrylate | 13.2% |
| | monomer | |
| CN 373 | amine acrylate monomer (with two | 6% |
| | crosslinkable double bonds) | |
| SR 399 | dipentaerythritol pentaacrylate monomer | 9.4% |
| Neorad U-10 | aliphatic urethane acrylate oligomers | 9.4% |
| Irgacure 184 | 1-hydroxycyclohexyl benzophenone | 2.8% |
| Darocure 1173 | 2-hydroxy-2-methyl propiophenone | 2.8% |
| | Total: | 100% |

### Comparative Example 9

### Not an Example of the Instant Claimed Invention

A radiation-curable composition comprising a combination of a tertiary amine compound having four crosslinkable double bonds and an amine value of 15.3 milligrams KOH per gram of the total radiation-curable resins in the composition, a urethane oligomer, a polymer, acrylate monomers, and photoinitiators, does not provide a UV-curable composition that is free of wrinkles upon curing of more than one directly adjacent section of a coated surface. The UV-curable coating comprises the materials provided in Table 9 below. A UV-curable coating is prepared comprising the materials listed in Table 9, then applied as a primer coating to a 10.16 cm×15.24 cm (4 inch×6 inch) metal substrate, to a thickness of 0.25 mm (10 mils). Next, the 0.25 mm (10 mil) thick coating is cured according to the method described in Example 1. Following curing of the first pass, observation of the cured clear primer coating within about one minute shows visible wrinkles.

TABLE 9
Comparative Example - Not an example of the instant claimed invention

| | | Amount (wt |
|---|---|---|
| Product | Chemical Type | %) |
| CN 820 | acrylic polymer (70%-80%) dissolved in | 22.2% |
| | acrylate monomer (20%-30%) | |
| SR 306 | tripropylene glycol diacrylate monomer | 11.1% |
| SR 454 | ethoxylated (3)₃ trimethyl propane | 11.1% |
| | triacrylate monomer | |
| SR 833 | tricyclodecane dimethanol diacrylate | 10.4% |
| | monomer | |
| CN 550 | amine acrylate monomer (with four | 26% |
| | crosslinkable double bonds) | |
| SR 399 | dipentaerythritol pentaacrylate monomer | 7.4% |
| Neorad U-10 | aliphatic urethane acrylate oligomers | 7.4% |
| Irgacure 184 | 1-hydroxycyclohexyl benzophenone | 2.2% |
| Darocure 1173 | 2-hydroxy-2-methyl propiophenone | 2.2% |
| | Total: | 100% |

### Comparative Example 10

### Not an Example of the Instant Claimed Invention

A radiation-curable composition comprising a combination of a urethane oligomer, a polymer, acrylate monomers, and photoinitiators does not provide a UV-curable composition that is free of wrinkles upon curing of more than one directly adjacent section of a coated surface. The UV-curable coating comprises the materials provided in Table 10 below. A UV-curable coating is prepared comprising the materials listed in Table 10, then applied as a primer coating to a 10.16 cm×15.24 cm (4 inch×6 inch) metal substrate, to a thickness of 0.25 mm (10 mils). Next, the 0.25 mm (10 mil) thick coating is cured according to the method described in Example 1. Following curing of the first pass, observation of the cured clear primer coating within about one minute shows visible wrinkles.

TABLE 10
Comparative Example - Not an example of the instant claimed invention

| Product | Chemical Type | Amount (wt %) |
|---|---|---|
| CN 820 | acrylic polymer (70%-80%) dissolved in | 30% |
| | acrylate monomer (20%-30%) | |
| SR 306 | tripropylene glycol diacrylate monomer | 15% |
| SR 454 | ethoxylated (3) trimethyl propane | 15% |
| | triacrylate monomer | |
| SR 833 | tricyclodecane dimethanol diacrylate | 14% |
| | monomer | |
| SR 399 | dipentaerythritol pentaacrylate monomer | 10% |
| Neorad U-10 | aliphatic urethane acrylate oligomers | 10% |
| Irgacure 184 | 1-hydroxycyclohexyl benzophenone | 3% |
| Darocure 1173 | 2-hydroxy-2-methyl propiophenone | 3% |
| | Total: | 100% |

### Comparative Example 11

### Not an Example of the Instant Claimed Invention

A sample starting point clear radiation-curable formulation provided on the Cytec Technical Data Sheet for Ebecryl® 891 does not result in a UV-cured composition that is free of wrinkles upon curing of more than one directly adjacent section of a coated surface. Ebecryl® 891 is a modified polyester acrylate having a theoretical acrylate functionality of 3.6 and a viscosity of 3,000 centipoises (at 25 degrees Celsius). Ebecryl® P115 is a tertiary amine with zero crosslinkable double bonds which provides and an amine value of 12.6 milligrams KOH per gram of the total radiation-curable resins in the composition in Table 11. The UV-curable coating comprises the materials provided in Table 11 below. A UV-curable coating is prepared comprising the materials listed in Table 11, then applied to a 10.16 cm×15.24 cm (4 inch×6 inch) metal substrate, to a thickness of 0.25 mm (10 mils). Next, the 0.25 mm (10 mil) thick coating is cured according to the method described in Example 1. Following curing of the first pass, observation of the cured clear coating within about one minute shows visible wrinkles.

TABLE 11
Comparative Example - Not an example of the instant claimed invention

| Product | Property | Amount (wt %) |
|---|---|---|
| Ebecryl ® 891 | coating performance | 25% |
| Ebecryl ® 81 | surface cure | 15% |
| Ebecryl ® 140 | Hardness | 20% |
| NPG(PO)2DA/ | viscosity reduction | 29.6% |
| DPGDA (50/50) | | |
| Additol ® BP | surface cure | 2% |
| Additol HDMAP | Multipurpose | 3% |
| Additol TPO | through cure | 0.4% |
| Ebecryl ® P115 | surface cure | 5% |
| EFKA ® 3600 | Defoamer | 0.15% |
| Surfynol ® 104 PA | Defoamer | 0.15% |
| | Total: | 100% |

### Example 12

A radiation-curable composition comprising a combination of a tertiary amine having zero cross-linkable double bonds, acrylate monomers, oligomers, a polymer and a photoinitiator successfully provides a UV-curable composition that is free of wrinkles upon curing of more than one directly adjacent section of a coated surface. The copolymerizable amine provides an amine value of 12.75 mg potassium hydroxide (KOH) per gram of the total radiation-curable resins of the coating composition. The UV-curable coating comprises the materials provided in Table 12 below. A UV-curable coating is prepared comprising the materials listed in Table 12, then applied as a primer coating to a 10.16 cm×15.24 cm (4 inch×6 inch) metal substrate, to a thickness of 0.25 mm (10 mils). Next, the 0.25 mm (10 mil) thick coating is cured according to the method described in Example 1. Following curing of the first pass, observation of the clear primer coat at the shoulder area shows no visible wrinkles for at least about 10 minutes before curing the next pass.

TABLE 12

| Product | Chemical Type | Amount (wt %) |
|---|---|---|
| SR399 | dipentaerythritol pentaacrylate | 8.5 |
| SR349 | ethoxylated 3 bisphenol A diacrylate | 34.5 |
| CN131B | aromatic monoacrylate oligomer | 35.25 |
| Palamoll 656 | adipic acid ester polymer | 11 |
| CN383 | tertiary amine with zero crosslinkable | 8.5 |
| | double bonds | |
| Irgacure 184 | 1-hydroxycyclohexyl benzophenone | 1.8 |
| Wetting agent | Wetting agent | 0.3 |
| Defoamer | Defoamer | 0.15 |
| | Total: | 100% |

### Example 13

A radiation-curable composition similar to the composition in Example 12 but with only 5% adipic acid ester polymer provides a UV-curable composition that exhibits wrinkles in the composition more rapidly than the composition in Example 11 The UV-curable coating comprises the materials provided in Table 13 below. A UV-curable coating is prepared comprising the materials listed in Table 13, then applied as a primer coating to a 10.16 cm×15.24 cm (4 inch×6 inch) metal substrate, to a thickness of 0.25 mm (10 mils). Next, the 0.25 mm (10 mil) thick coating is cured according to the method described in Example 1. Following curing of the first pass, observation of the clear primer coat at the shoulder area shows wrinkles in the shoulder area 4 minutes after curing of the pass.

TABLE 13

| Product | Chemical Type | Amount (wt %) |
|---|---|---|
| SR399 | dipentaerythritol pentaacrylate | 9.1 |
| SR349 | ethoxylated 3 bisphenol A diacrylate | 36.9 |
| CN131B | aromatic monoacrylate oligomer | 37.65 |
| Palamoll 656 | adipic acid ester polymer | 5.0 |
| CN383 | tertiary amine with zero crosslinkable | 9.1 |
| | double bonds | |
| Irgacure 184 | 1-hydroxycyclohexyl benzophenone | 1.8 |
| Wetting agent | Wetting agent | 0.3 |
| Defoamer | Defoamer | 0.15 |
| | Total: | 100% |

### Comparative Example 14

### Not an Example of the Instant Claimed Invention

A radiation-curable composition similar to the composition in Example 12 but with no tertiary amine compound fails to provide a UV-curable composition that is free of wrinkles upon curing of more than one directly adjacent section of a coated surface. The UV-curable coating comprises the materials provided in Table 14 below. A UV-curable coating is prepared comprising the materials listed in Table 14, then applied as a primer coating to a 10.16 cm×15.24 cm (4 inch×6 inch) metal substrate, to a thickness of 0.25 mm (10 mils). Next, the 0.25 mm (10 mil) thick coating is cured according to the method described in Example 1. Following curing of the first pass, observation of the clear primer coat at the shoulder area shows wrinkles 1.5 minutes after curing of the pass.

TABLE 14
Comparative Example - Not an example of the instant claimed invention

| Product | Chemical Type | Amount (wt %) |
|---|---|---|
| SR399 | dipentaerythritol pentaacrylate | 9.3 |
| SR349 | ethoxylated 3 bisphenol A diacrylate | 37.8 |
| CN131B | aromatic monoacrylate oligomer | 38.6 |
| Palamoll 656 | adipic acid ester polymer | 12.05 |
| CN383 | tertiary amine with zero crosslinkable | 0.0 |
| | double bonds | |
| Irgacure 184 | 1-hydroxycyclohexyl benzophenone | 1.8 |
| Wetting agent | Wetting agent | 0.3 |
| Defoamer | Defoamer | 0.15 |
| | Total: | 100% |

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context. The claims are to be construed to include alternative embodiments to the extent permitted by the prior art.

1. A radiation-curable coating composition for a floor comprising:
at least one multifunctional monomer or oligomer;
at least one photoinitiator;
at least one polymer; and
one or more tertiary amine compounds comprising zero or one acrylate crosslinkable double bonds.

2. The coating composition of claim 1, wherein the coating composition is a clear primer coating composition for concrete or wherein the coating composition is a clear topcoat coating composition.

3. The coating composition of claim 1, wherein when the coating composition is applied to a surface at a thickness of at least 0.15 mm, and when the coating composition on the surface is subjected to a plurality of curing passes of a UV radiation source and the time lapse between the start of any one of the plurality of curing passes and the finish of the next directly adjacent curing pass is at least two minutes, preferably at least three minutes, more preferably at least four minutes, the cured composition has no wrinkle,
wherein the UV radiation is preferably emitted by a source selected from the group consisting of at least one lamp, at least one bulb, at least one LED, and combinations thereof,
preferably the shoulder area of the predetermined area that is directly adjacent the first portion and has not had the UV radiation source pass directly over it, has no wrinkle about two minutes following the completion of the passing of the UV radiation source over the first portion.

4. The coating composition according to claim 3, wherein when the composition is applied over a predetermined area of a surface of a concrete floor at a thickness of at least 0.15 mm (6 mils) on the surface, and a radiation source is passed over a first portion of the predetermined area of the surface to cure the coating composition, a shoulder area that is part of the predetermined area and directly adjacent to the main body area and has not had the UV radiation source pass over but has stray light leaked from the side of the light shield of the UV curing machine, it has no wrinkles about two minutes following the completion of the passing of the radiation source over the first portion.

5. The coating composition according to claim 1, wherein the at least one photoinitiator comprises a Norrish Type I photoinitiator selected from the group consisting of acyl phosphine oxides, benzoin ethers, 2,2-diethoxyacetophenone, benzyl dimethylketal, 1-hydroxycyclohexylphenyl-ketone, 1-hydroxycyclohexyl benzophenone, 2-hydroxy-2-methyl propiophenone, 2-ethoxy-2-isobutoxyacetophenone, 2,2-dimethyl-2-hydroxyacetophenone, 2,2-dimethoxy-2-phenylacetophenone, 2,2,2-trichloro-4-t-butylacetophenone, 2,2-dimethyl-2-hydroxy-4-t-butylacetophenone, 1-phenyl-1,2-propanedione-2-O-ethoxycarbonyl ester, 1-phenyl-1,2-propanedione-2-O-benzoyl oxime and combinations thereof.

6. The coating composition according to claim 1, wherein the at least one tertiary amine is selected from the group consisting of triethylamine, triethanolamine, N,N-dimethyl-p-toluidine, methyldiethanolamine, dimethylethanolamine, 2-n-butoxyethyl-4-dimethylaminohenzoate, 2-ethyl-p-(N,N-dimethylamino)benzoate, 2-ethylhexyl-p-dimethylaminobenzoate, salts thereof and combinations thereof.

7. The coating composition according to claim 1, wherein the coating composition is applied to a surface at a thickness of at least 0.18 mm, at least 0.20 mm, at least 0.23 mm, at least 0.25 mm, at least 0.28 mm, at least 0.30 mm, at least 0.33 mm, at least 0.38 mm, at least 0.39 mm, at least 0.40 mm, at least 0.43 mm, at least 0.46 mm, at least 0.48 mm, or at least 0.51 mm.

8. The coating composition according to claim 1, further comprising at least one filler.

9. The coating composition according to claim 1, wherein the one or more tertiary amine compounds are present in an amount providing an amine value of at least 7.5 mg potassium hydroxide (KOH) per gram of total radiation-curable resins of the coating composition, at least 9 mg potassium hydroxide (KOH) per gram of total radiation-curable resins of the coating composition, at least 15 mg potassium hydroxide (KOH) per gram of total radiation-curable resins of the coating composition, at least 19.5 mg potassium hydroxide (KOH) per gram of total radiation-curable resins of the coating composition.

10. The coating composition according to claim 1, wherein the polymer is a non-acrylate-functionalized polymer, and wherein the lower limit of the number average molecular weight of the non-acrylated polymer is preferably 5000 g/mol.

11. A method for coating a concrete floor comprising:
applying a coating composition according to claim 1 in a predetermined area over a surface of a concrete floor, wherein the coating composition comprises a thickness of at least 0.15 mm on the surface; and
passing a UV radiation source over a first portion of the predetermined area of the surface to cure the coating composition,
wherein a shoulder area of the predetermined area that includes partially cured coating, that is directly adjacent the first portion and that has not had the UV radiation source pass directly over it, has no wrinkles at least two minutes, preferably at least three minutes, more preferably at least four minutes, following the completion of the passing of the UV radiation source over the first portion,
wherein the UV radiation source preferably provides radiation wavelengths between about 100 ran and about 700 nm, and more preferably the UV radiation is emitted by a source selected from the group consisting of at least one lamp, at least one bulb, at least one LED, and combinations thereof.

12. The method of claim 11, wherein the radiation source is passed over the predetermined area of the concrete surface at a speed of between about 6.1 m per minute and about 18.3 m per minute.

13. The method of claim 10, wherein the shoulder area has a width of at least about 0.5 cm.

14. A coated concrete floor, comprising:
a concrete floor comprising a surface; and
a radiation-curable coating composition according to claim 1 applied directly to the surface, wherein the coating composition has a thickness of at least 0.15 mm, and wherein preferably said coating composition is clear.

15. The coated concrete floor of claim 14, wherein when the coating composition is subjected to a plurality of curing passes of a UV radiation source and the time lapse between the start of any one of the plurality of curing passes and the finish of the next directly adjacent curing pass is at least about two minutes, preferably at least three minutes, more preferably at least four minutes, the cured composition on the surface has no wrinkle, wherein a first one of the plurality of curing passes preferably overlaps a second one of the plurality of curing passes by at least five cm.
